(19) United States
(12) Patent Application Publication
(10) Pub. No.: US 2011/0274966 A1
(43) Pub. Date: Nov. 10, 2011

(54) NONAQUEOUS ELECTROLYTIC SOLUTION SECONDARY BATTERY AND METHOD FOR PRODUCING THE SAME

(75) Inventors: Jiro Iriyama, Kanagawa (JP); Tatsuji Numata, Kanagawa (JP); Ryuichi Kasahara, Kanagawa (JP); Tetsuya Kajita, Kanagawa (JP)

(73) Assignee: NEC Energy Devices Ltd

(21) Appl. No.: 13/145,055

(22) PCT Filed: Jan. 19, 2010
(86) PCT No.: PCT/JP2010/050528

§ 371 Date: Jul. 18, 2011

(30) Foreign Application Priority Data
Jan. 19, 2009 (JP) 2009 008567

(51) Int. Cl. H01M 10/05; H01M 2/08; H01M 2/02

(52) U.S. Cl. 429/163; 156/303.1

(57) ABSTRACT

An exemplary embodiment of the invention provides a nonaqueous electrolytic solution secondary battery in which capacity deterioration associated with a charge/discharge cycle at a high temperature (45° C. or higher) can be prevented. An exemplary embodiment of the invention is a nonaqueous electrolytic solution secondary battery, comprising an electrode element in which a cathode and an anode are stacked, a nonaqueous electrolytic solution which contains at least one of carbonate solvent, and a gel in an outer packaging body; wherein the anode comprises a silicon oxide represented by SiOₓ (0<x≦2) as an anode active material, and the gel comprises a cross-linked unsaturated carboxylate ester polymer and a carbonate solvent which is the same as at least one of the carbonate solvent contained in the nonaqueous electrolytic solution.

### TECHNICAL FIELD

An exemplary embodiment of the invention relates to a nonaqueous electrolytic solution secondary battery and a method for producing the same.

### BACKGROUND ART

With rapidly expanding the market of laptop computers, mobile phones, electric vehicles, and the like, a nonaqueous electrolytic solution secondary battery having a high energy density is required. Examples of a method for obtaining a nonaqueous electrolytic solution secondary battery having a high energy density include a method in which an anode material having large capacity is used, and a method in which a lightweight lamination film is used as an outer packaging body.

Since the nonaqueous electrolytic solution secondary battery has a high output voltage and a high energy density, it is preferable. On the other hand, however, since a nonconductor compound is produced in the anode by charging and discharging and carbon dioxide gas is generated in the nonaqueous electrolytic solution secondary battery, there is a problem in which capacity deterioration associated with a cycle will occurs.

It is disclosed in Patent document 1 that, in the case of using a silicon oxide that contains lithium as an anode active material, the amount of lithium ion which can be reversibly absorbed and desorbed by charging and discharging, that is charge/discharge capacity, is remarkably high and polarization of charging and discharging is small, resulting that deterioration such as generation of a non-reversible compound by overcharging and overdischarging rarely occurs, and that it is possible to obtain a secondary battery which is extremely stable and which has a long cycle life.

Also, it is disclosed in Patent document 2 that a carbon dioxide absorber which consists of a cross-linked polymer having a —COOR group directly bonded to a main chain and a liquid medium has high carbon dioxide absorbability without using a metal that interacts with carbon dioxide or a compound having a functional group which reacts with carbon dioxide.

### PRIOR ART DOCUMENT

### Patent Document

Patent document 1: JP 2997741 B
Patent document 2: JP 2007-209975 A

### SUMMARY OF THE INVENTION

### Problem to be Solved by the Invention

When charging and discharging are carried out at 45° C. or higher in the case of the silicon oxide described in Patent document 1, capacity deterioration associated with a charge/discharge cycle might significantly increase. If carbon dioxide is generated in the battery, capacity deterioration associated with a charge/discharge cycle becomes significant, because carbon dioxide that is generated accumulates between an cathode and an anode, which distorts an electrode element, and partial loss of an electrolytic solution occurs.

In order to prevent this, a carbon dioxide absorber is used to absorb carbon dioxide gas. However, the carbon dioxide absorber of Patent document 2 is a film, resulting that the contact to the electrode is insufficient and carbon dioxide might not be promptly absorbed. In addition, since a liquid solvent in the carbon dioxide absorber is selected independently of the electrolytic solution of the power storage device, carbon dioxide absorbability in the battery might be insufficient.

That is, the technical problem of an exemplary embodiment of the invention is to provide a nonaqueous electrolytic solution secondary battery in which capacity deterioration associated with a charge/discharge cycle at a high temperature (45° C. or higher) can be prevented.

### Means for Solving the Problem

A nonaqueous electrolytic solution secondary battery according to an exemplary embodiment of the invention comprises an electrode element in which a cathode and an anode are stacked, a nonaqueous electrolytic solution which contains at least one of carbonate solvent, and a gel in an outer packaging body; wherein the anode comprises a silicon oxide represented by SiOₓ (0<x≦2) as an anode active material, and the gel comprises a cross-linked unsaturated carboxylate ester polymer and a carbonate solvent which is the same as at least one of the carbonate solvent contained in the nonaqueous electrolytic solution.

A method for producing a nonaqueous electrolytic solution secondary battery according to an exemplary embodiment of the invention is the method for producing the above-mentioned nonaqueous electrolytic solution secondary battery, comprising: sealing the outer packaging body in a condition in which the electrode element, the nonaqueous electrolytic solution, and a cross-linked polymer precursor composition containing an unsaturated carboxylate ester are embedded in the outer packaging body, and polymerizing the unsaturated carboxylate ester.

### Effect of the Invention

By an exemplary embodiment of the invention, carbon dioxide generated can promptly be absorbed to prevent distortion of an electrode element and partial loss of an electrolytic solution, which make it possible to provide a nonaqueous electrolytic solution secondary battery in which capacity deterioration associated with a charge/discharge cycle at a high temperature (45° C. or higher) can be prevented.

### BRIEF DESCRIPTION OF DRAWINGS

FIG. 1 is a schematic view showing a stacked structure of an electrode element in a nonaqueous electrolytic solution secondary battery according to an exemplary embodiment of the invention.

### MODE FOR CARRYING OUT THE INVENTION

As follows, an exemplary embodiment of the invention is explained.

For example, if carbon or lithium titanate is used as the anode active material, carbon dioxide gas is rarely generated by charging and discharging. However, if a silicon oxide is used as the anode active material, carbon dioxide gas is generated by charging and discharging. The generation of carbon dioxide is significant under an environment of 45° C. or higher.

Further, capacity deterioration associated with a charge/discharge cycle at 45° C. or higher, which is observed in a nonaqueous electrolytic solution secondary battery using the silicon oxide as the anode active material, is found to be due to the retention of carbon dioxide gas internally generated between a cathode and an anode, which leads to distortion of electrode structure or due to occurrence of partial loss of an electrolytic solution.

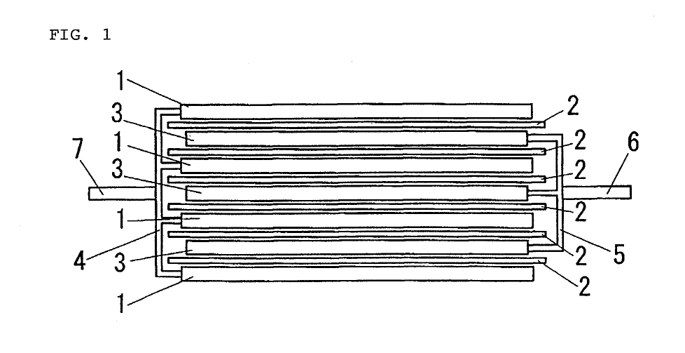

FIG. 1 is a schematic view showing a stacked structure of an electrode element in a nonaqueous electrolytic solution secondary battery according to an exemplary embodiment of the invention. In this electrode element, a plurality of cathodes 3 and a plurality of anodes 1 are stacked through separators 2. Cathode collector 5 included in cathode 3 and anode collector 4 included in anode 1 are respectively gathered and are electrically connected with cathode terminal 6 and anode terminal 7, respectively.

There is an advantage in the electrode element having such planar stacking structure that it is hardly affected by a volume change of the electrode associated with charging and discharging, in comparison with an electrode element having spiral structure. This is because the electrode is bent in the electrode element having spiral structure, which results in distortion of the structure due to volume change. In particular, in the case of using an electrode material such as a silicon oxide which generates a large volume change associated with charging and discharging as anode, large capacity deterioration associated with charging and discharging occurs in the nonaqueous electrolytic solution secondary battery using the electrode element having a spiral structure.

On the other hand, in the case of an electrode element having a planar stacking structure, there is a problem of retention of carbon dioxide gas generated between the electrodes. This is because, in the case of the electrode element having a planar stacking structure, it is easy to extend the space between the cathode and the anode electrode when carbon dioxide gas is generated. In contrast, in the case of the electrode element having a spiral structure, the electrodes are tensioned therebetween and thereby the space between the cathode and the anode electrode is not extended when carbon dioxide gas is generated. In the case where the outer packaging body is an aluminum lamination film, this problem becomes particularly significant.

However, if a gel containing a cross-linked unsaturated carboxylate ester polymer and a carbonate solvent is placed in the outer packaging body, the gel absorbs carbon dioxide generated to prevent distortion of an electrode element and partial loss of an electrolytic solution, which make it possible to considerably prevent capacity deterioration associated with a charge/discharge cycle at 45° C. or higher.

That is, by using a gel in which a cross-linked unsaturated carboxylate ester polymer is impregnated with a carbonate solvent, interaction between —COO— part of the cross-linked polymer and a carbon dioxide molecule becomes strong, with the result that carbon dioxide comes to be absorbed in the gel.

### (1) Cathode Active Material

A cathode is obtained by forming a cathode active material layer that contains a cathode active material on a collector. Examples of cathode active material include transition metal oxides such as lithium manganates having a layered structure or lithium manganates having a Spinel structure including LiMnO₂ and LiₓMn₂O₄ (0<x<2), LiCoO₂, LiNiO₂ and materials in which a part of transition metal thereof are substituted with another metal. The cathode active material can be used alone, or in combination of two or more kinds.

### (2) Anode Active Material

An anode is obtained by foaming an anode active material layer containing an anode active material on a collector. In an exemplary embodiment of the invention, a silicon oxide is represented by SiOₓ (0<x≦2) as the anode active material. When x becomes larger than 2, the non-reversible capacity of the battery becomes large, resulting in decreased energy density thereof. The value of x is preferable in a range of 0.7≦x≦1. When x is set to be 1 or smaller, the non-reversible capacity of the battery becomes smaller, resulting in increased energy density thereof. In addition, when x is set to be larger than 0.7, it becomes easier to synthesize SiOₓ.

One kind or plural kinds of elements selected from nitrogen, boron and sulfur may be added to the silicon oxide. When the element is added at a range of 0.1% by weight or more and 5% by weight or less, the electroconductive property of the silicon oxide can be improved.

Carbon, Li metal, Li titanate and the like are known as an anode active material used for a nonaqueous electrolytic solution secondary battery. However, gas is rarely generated in a charge/discharge cycle at 45° C. or higher if Li titanate is used as an anode active material, while a gas containing olefin as a main component is generated in a charge/discharge cycle at 45° C. or higher if carbon or Li metal is used as an anode active material. On the contrary, if a silicon oxide is used as an anode active material, a gas containing carbon dioxide as a main component is found to be generated in a charge/discharge cycle at 45° C. or higher. Thus, in an exemplary embodiment of the invention, in order to solve the problem that occurs in the case where a silicon oxide is used as an anode active material, a cross-linked unsaturated carboxylate ester polymer having the absorption effect of carbon dioxide is adopted.

### (3) Collector

A collector can be selected from, but should not be limited to, collectors which are already known. As a collector, aluminum, nickel, copper, silver and alloys thereof are preferable from the standpoint of electrochemical stability. As for the configuration, for example, a foil, flat tabular or mesh collector can be used. In addition, a thin film of aluminum, nickel and alloys thereof onto an active material layer may be formed by the method of deposition, sputtering or the like to make a collector.

### (4) Electroconductive Auxiliary Material

When an electrode (cathode or anode) is formed, an electroconductive auxiliary material may be mixed with a cathode active material or an anode active material for the purpose of reducing impedance. The electroconductive auxiliary material can be selected from, but should not be limited to, electroconductive auxiliary materials which are already known. Examples of electroconductive auxiliary materials include carbonaceous fine particles such as graphite, carbon black, and acetylene black.

### (5) Binder

In order to strengthen adhesion between constituent materials of an electrode (cathode or anode), a binder may be mixed with a cathode active material or an anode active material. The binder can be selected from, but should not be limited to, binders which are already known. Examples of the binder include polyvinylidene fluorides, vinylidene fluoride—hexafluoropropylene copolymers, vinylidene fluoride—tetrafluoroethylene copolymers, styrene-butadiene copolymer rubbers, polytetrafluoroethylenes, polypropylenes, polyethylenes, polyimides, and polyamide-imides.

### (6) Separator

The separator can be selected from, but should not be limited to, separators which are already known. Examples of the separator include porous films and nonwoven cloths which are made of polypropylene, polyethylene, or the like.

### (7) Nonaqueous Electrolytic Solution

As a nonaqueous electrolytic solution, a solution obtained by dissolving an electrolyte salt in at least one carbonate solvent can be used. Examples of the carbonate solvent include cyclic carbonates such as ethylene carbonate, propylene carbonate, butylene carbonate, and vinylene carbonate; and chain carbonates such as dimethyl carbonate, diethyl carbonate, ethyl methyl carbonate, and dipropyl carbonate. The carbonate solvent can be used alone, or in combination with two or more kinds. To the carbonate solvent may be mixed an ionic liquid, examples of which include lactones such as γ-butyl lactone and quaternary ammonium—imide salts.

Examples of the electrolyte salts include lithium salts such as LiPF₆, LiAsF₆, LiAlCl₄, LiClO₄, LiBF₄, LiSbF₆, LiCF₃SO₃, LiCF₃CO₂, Li(CF₃SO₂)₂, LiN(CF₃SO₂)₂. The electrolyte salt can be used alone, or in combination with two or more kinds.

### (8) Gel

A gel is obtained by impregnating a cross-linked unsaturated carboxylate ester polymer with a carbonate solvent. The cross-linked unsaturated carboxylate ester polymer may be, but should not be limited to, a polymer having a structural unit represented by chemical formula (I). From the standpoint of more effectively preventing capacity deterioration associated with a charge/discharge cycle at 45° C. or higher, the cross-linked unsaturated carboxylate ester polymer preferably has a structural unit represented by chemical formula (I) at a ratio of 50 unit % or more. It is more preferable that virtually every unit is a structural unit represented by chemical formula (1).

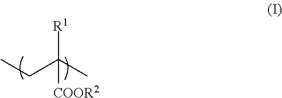

In the formula, R¹ represents hydrogen or an alkyl group having a carbon number of 1 to 3, R² represents an alkyl group having a carbon number of 1 to 3. The alkyl group having a carbon number of 1 to 3 for R¹ or R² is respectively independently selected from methyl group, ethyl group, n-propyl group, and an isopropyl group.

As a polymer used for forming a gel for a nonaqueous electrolytic solution secondary battery, polymers such as PAN, PVdF are known, but these polymers do not have the absorption effect of carbon dioxide.

The carbonate solvent contained in the gel is not limited as long as it is stable at the operation voltage of the battery. Preferably, examples thereof include cyclic carbonates such as ethylene carbonate, propylene carbonate, butylene carbonate, and vinylene carbonate; and chain carbonates such as dimethyl carbonate, diethyl carbonate, ethyl methyl carbonate, and dipropyl carbonate. The carbonate solvent can be used alone, or in combination with two or more kinds.

Note that, the gel needs to contain a carbonate solvent which is the same as at least one of the carbonate solvents contained in the nonaqueous electrolytic solution. This is because a side reaction in the battery can be controlled to prevent capacity deterioration associated with a charge/discharge cycle by making the gel contain a carbonate solvent which is the same as at least one of the carbonate solvent of the nonaqueous electrolytic solution.

The amount of the cross-linked unsaturated carboxylate ester polymer existing in the gel is preferably 1 part by weight or more and 20 parts by weight or less with respect to 100 parts by weight of the carbonate solvent existing in the gel.

A nonaqueous electrolytic solution and a gel may exist apart from each other. In this case, since an electrolyte salt is not dissolved in a carbonate solvent contained in the gel, the carbonate solvent does not function as a solvent of the nonaqueous electrolytic solution. That is, the carbonate solvent contained in the gel is distinguished from the carbonate solvent contained in the nonaqueous electrolytic solution.

In this case, the amount of the gel is preferably 2 parts by weight or more and 20 parts by weight or less with respect to 100 parts by weight of the nonaqueous electrolytic solution. When the amount of the gel is set to be 2 parts by weight or more, gelation easily occurs. When the amount of the gel is set to be 20 part by weight or less, electric resistance decreases and design property is easily provided.

A nonaqueous electrolytic solution and a gel may be integrated and the nonaqueous electrolytic solution may exist in the gel. In this case, an electrolyte salt is dissolved in a carbonate solvent contained in the gel, and the carbonate solvent functions as a solvent of the nonaqueous electrolytic solution. That is, the carbonate solvent contained in the gel completely corresponds to the carbonate solvent contained in the nonaqueous electrolytic solution.

The method of embedding a gel in an outer packaging body may be a method of filling a previously obtained gel into the outer packaging body, but is preferably a method of filling a cross-linked polymer precursor composition into the outer packaging body and thereafter gelating it in the outer packaging body by heating or the like. This is because that, by subsequent gelation in the outer packaging body, the electrode and the gel can be integrated and the contact area thereof can increase and because carbon dioxide generated from the electrode can promptly be absorbed.

For example, the cross-linked polymer precursor composition contains an unsaturated carboxylate ester, a cross-linked part formation material, and a polymerization initiator. As the unsaturated carboxylate ester, methyl (meth)acrylate, ethyl (meth)acrylate, n-propyl (meth)acrylate, isopropyl (meth)acrylate, and the like can be used.

As the cross-linked part formation material, ethylene glycol di(meth)acrylate, propylene glycol di(meth)acrylate, 1,4-butanediol di(meth)acrylate, and the like can be used.

As the polymerization initiator, azobis(isobutyronitrile), benzoyl peroxide, and the like can be used.

The weight mixing ratio of the unsaturated carboxylate ester, the cross-linked part formation material and the polymerization initiator is preferably selected from the range of 70-95:20-4.5:10-0.5 from the standpoint of occurrence of gelation reaction. If the amount of the polymerization initiator is excessive and it remains in the outer packaging body, the capacity of the battery might deteriorate.

The polymerization temperature is preferably set to be 70° C. or higher and 120° C. or lower. When the polymerization temperature is set to be 70° C. or higher, the gelation reaction is sufficient. When the polymerization temperature is set to be 120° C. or lower, deterioration of the properties of the electrode element, such as the separator, can be prevented.

The polymerization time is preferably set to be 1 hour or longer and 12 hours or shorter. When the polymerization time is set to be 1 hour or longer, the gelation reaction is sufficient. When the polymerization time is set to be 12 hours or shorter, capacity deterioration of the battery can be prevented.

### (9) Outer Packaging Body

An outer packaging body is not limited as long as it is stable against an electrolytic solution and it has a water vapor barrier property, and is preferably a lamination film of polypropylene, polyethylene, or the like which is coated with aluminum or silica.

In the case of a nonaqueous electrolytic solution secondary battery in which a lamination film is used as an outer packaging body, when gas is generated, distortion of the electrode element becomes much larger, than in the case of a nonaqueous electrolytic solution secondary battery whose outer packaging consists of a metal can. This is because the lamination film is easily deformed by the inner pressure of the battery in comparison with the metal can. Even more particularly, in the case of the nonaqueous electrolytic solution secondary battery whose outer packaging consists of lamination film, the inner pressure of the battery is generally set to be lower than atmospheric pressure when it is encapsulated. Thus, the nonaqueous electrolytic solution secondary battery in which a lamination film is used as an outer packaging body does not have extra space, directly resulting in volume change of the nonaqueous electrolytic solution secondary battery and in deformation of the electrode element. Therefore, the advantageous effect by an exemplary embodiment of the invention is significant.

### EXAMPLE

As follows, Example of an exemplary embodiment of the invention is described in detail.

A silicon monoxide (produced by Kojundo Chemical Laboratory, average particle diameter D₅₀=25 μm) as an anode active material, carbon black as an electroconductive auxiliary material, and a polyimide (produced by UBE INDUSTRIES, trade name: U vanish A) as a binder were respectively weighed at a weight ratio of 83:2:15, and they were mixed with n-methylpyrrolidone to obtain a slurry. The obtained slurry was applied on a copper foil with a thickness of 10 μm and was then dried to obtain an anode.

Lithium cobaltate as a cathode active material, a carbon black as an electroconductive auxiliary material, and a polyvinylidene fluoride as a binder were respectively weighed at a weight ratio of 95:2:3, and they were mixed with n-methylpyrrolidone to obtain a slurry. The obtained slurry was applied on an aluminum foil with a thickness of 20 μm and was then dried to obtain an cathode.

The obtained cathodes and anodes were alternately stacked with a polypropylene porous film as a separator placed therebetween to form an electrode element having a planar stacking structure. The collector end parts of the cathodes and anodes, which were not covered with the active material layer thereof, were respectively gathered and welded, and further a nickel cathode terminal and a nickel anode terminal were respectively welded thereto.

This electrode element was embedded in an aluminum lamination film, and a mixture of a nonaqueous electrolytic solution and a cross-linked polymer precursor composition was poured thereinto. The aluminum lamination film was depressurized to 0.1 atm and was encapsulated to produce a sheet-type nonaqueous electrolytic solution secondary battery.

A liquid which was obtained by dissolving LiPF₆ at a concentration of 1 mol/l in a solvent in which ethylene carbonate, diethyl carbonate and methyl ethyl carbonate were mixed at a volume ratio of 3:2:5 was used as the nonaqueous electrolytic solution. A liquid which was obtained by mixing methyl methacrylate, ethylene glycol diacrylate and 2,2′-azobis(isobutyronitrile) at a weight ratio of 20:2:1 was used as the cross-linked polymer precursor composition. The mixing weight ratio of the nonaqueous electrolytic solution and the cross-linked polymer precursor composition was set to 90:10.

The obtained nonaqueous electrolytic solution secondary battery was kept at 80° C. for 2 hours to form, in the nonaqueous electrolytic solution secondary battery, a gel which consists of a cross-linked poly(methyl methacrylate) and a mixed solvent of ethylene carbonate, diethyl carbonate and methyl ethyl carbonate.

### Comparative Example

77.2 mg of 2,2′-azobis(isobutyronitrile) was added to a mixture of 10.00 g of methyl methacrylate and 0.30 g of ethylene glycol dimethacrylate, and it was deoxidized and was then stirred for five minutes. The obtained mixture was heated at 70° C. for 7 hours for polymerization, and a cross-linked poly(methyl methacrylate) film with a thickness of 400 μm was then produced. The obtained film was impregnated with propylene carbonate as a solvent to obtain a carbon dioxide absorber.

The obtained carbon dioxide absorber was placed on the electrode element produced in Example. It was embedded in an aluminum lamination film, and only the same nonaqueous electrolytic solution as that of Example was poured thereinto without pouring a cross-linked polymer precursor composition. The aluminum lamination film was depressurized to 0.1 atm and was encapsulated to produce a sheet-type nonaqueous electrolytic solution secondary battery.

In a thermostatic oven which was kept at a temperature of 45° C., the nonaqueous electrolytic solution secondary batteries produced in Example and Comparative Example were repeatedly charged and discharged within a voltage range of 3.0 V to 4.2 V. Results of C30/C1 in the nonaqueous electrolytic solution secondary batteries produced in Example and Comparative Example were shown in Table 1. Here, C30/C1 means (discharged capacity at the 30^{th} cycle)/(discharged capacity at the 1^{st} cycle) (%).

TABLE 1

| | C30/C1 |
|---|---|
| Example | 92% |
| Comparative Example | 18% |

From Table 1, the nonaqueous electrolytic solution secondary battery produced in Example was found to have a larger ratio of the discharged capacity at the 30^{th} cycle with respect to the discharged capacity at the 1^{st} cycle than that of the nonaqueous electrolytic solution secondary battery produced in Comparative Example. It has been revealed from this result that capacity deterioration associated with a charge/discharge cycle at 45° C. can be improved by an exemplary embodiment of the invention even if a silicon oxide was used as an anode active material in a nonaqueous electrolytic solution secondary battery,

By an exemplary embodiment of the invention, carbon dioxide that is generated can promptly be absorbed to prevent distortion of an electrode element and partial loss of an electrolytic solution, which made it possible to provide a nonaqueous electrolytic solution secondary battery in which capacity deterioration associated with a charge/discharge cycle at a high temperature (45° C. or higher) can be prevented.

Above, a mode for carrying out the present invention was explained using Example, but the present invention is not limited to the Example and the present invention includes a mode in which there is a design variation without departing from the scope of the present invention. That is, the present invention includes a mode in which various changes or adjustments may be made by a person ordinarily skilled in the art.

The present application claims priority based on Japanese Patent Application No. 2009-8567, filed on Jan. 19, 2009, all the disclosure of which is incorporated herein by reference.

### EXPLANATION OF SYMBOL

1 anode
2 separator
3 cathode
4 anode collector
5 cathode collector
6 cathode terminal
7 anode terminal

1. A nonaqueous electrolytic solution secondary battery, comprising an electrode element in which a cathode and an anode are stacked, a nonaqueous electrolytic solution which contains at least one of carbonate solvent, and a gel in an outer packaging body;
wherein the anode comprises a silicon oxide represented by SiOₓ (0<x≦2) as an anode active material, and
the gel comprises a cross-linked unsaturated carboxylate ester polymer and a carbonate solvent which is the same as at least one of the carbonate solvent contained in the nonaqueous electrolytic solution.

2. The nonaqueous electrolytic solution secondary battery according to claim 1, wherein the cross-linked unsaturated carboxylate ester polymer has a structural unit represented by following chemical formula (1): 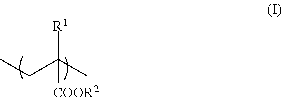
wherein, in the formula, R¹ represents hydrogen or an alkyl group having a carbon number of 1 to 3, R² represents an alkyl group having a carbon number of 1 to 3.

3. The nonaqueous electrolytic solution secondary battery according to claim 1, wherein the outer packaging body is a lamination film.

4. The nonaqueous electrolytic solution secondary battery according to claim 1, wherein the unsaturated carboxylate ester polymer is obtained by sealing the outer packaging body in a condition in which the electrode element, the nonaqueous electrolytic solution, and a cross-linked polymer precursor composition containing an unsaturated carboxylate ester are embedded in the outer packaging body, and thereafter polymerizing the unsaturated carboxylate ester.

5. The nonaqueous electrolytic solution secondary battery according to claim 4, wherein the cross-linked polymer precursor composition comprises the unsaturated carboxylate ester, a cross-linking part formation material, and a polymerization initiator.

6. A method for producing the nonaqueous electrolytic solution secondary battery according to claim 4, comprising:
sealing the outer packaging body in a condition in which the electrode element, the nonaqueous electrolytic solution, and a cross-linked polymer precursor composition containing an unsaturated carboxylate ester are embedded in the outer packaging body, and
polymerizing the unsaturated carboxylate ester.

7. The nonaqueous electrolytic solution secondary battery according to claim 2, wherein the outer packaging body is a lamination film.

8. The nonaqueous electrolytic solution secondary battery according to claim 2, wherein the unsaturated carboxylate ester polymer is obtained by sealing the outer packaging body in a condition in which the electrode element, the nonaqueous electrolytic solution, and a cross-linked polymer precursor composition containing an unsaturated carboxylate ester are embedded in the outer packaging body, and thereafter polymerizing the unsaturated carboxylate ester.

9. The nonaqueous electrolytic solution secondary battery according to claim 3, wherein the unsaturated carboxylate ester polymer is obtained by sealing the outer packaging body in a condition in which the electrode element, the nonaqueous electrolytic solution, and a cross-linked polymer precursor composition containing an unsaturated carboxylate ester are embedded in the outer packaging body, and thereafter polymerizing the unsaturated carboxylate ester.

10. The nonaqueous electrolytic solution secondary battery according to claim 8, wherein the cross-linked polymer precursor composition comprises the unsaturated carboxylate ester, a cross-linking part formation material, and a polymerization initiator.

11. The nonaqueous electrolytic solution secondary battery according to claim 9, wherein the cross-linked polymer precursor composition comprises the unsaturated carboxylate ester, a cross-linking part formation material, and a polymerization initiator.
